(19) United States
(12) Patent Application Publication
(10) Pub. No.: US 2006/0290599 A1
(43) Pub. Date: Dec. 28, 2006

(54) Plasma display apparatus and driving method thereof

(75) Inventor: Ji-seung Yoo, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/472,284

(22) Filed: Jun. 22, 2006

(30) Foreign Application Priority Data
Jun. 24, 2005 (KR) 10-2005-0055334
Jun. 24, 2005 (KR) 10-2005-0055335

(51) Int. Cl. G09G 3/28

(52) U.S. Cl. 345/60

(57) ABSTRACT

A plasma display apparatus and a driving method thereof are provided. A plasma display apparatus comprises a plasma display panel comprising address electrodes, a data driver for supplying a data voltage and a first voltage with a voltage that is more than a ground voltage to the address electrodes and a driving voltage generator for generating the first voltage and the data voltage and for supplying the first voltage and the data voltage to the data driver. A driving method comprises supplying a ground voltage to address electrodes during a reset period, supplying a first voltage that is more than the ground voltage to the address electrodes during an address period, supplying a scan reference voltage to scan electrodes during the address period, supplying a data voltage to the address electrodes during the address period, and supplying the ground voltage to the address electrodes during a sustain period.

This non-provisional application claims priority under 35 U.S.C. § 119(a) on Patent Application Nos. 10-2005-0055334 and 10-2005-0055335 filed in Korea on Jun. 24, 2005 the entire contents of which are hereby incorporated by reference.

### BACKGROUND OF THE INVENTION

1. Field of the Invention

This document invention relates to a plasma display apparatus, and more particularly, to a plasma display apparatus and a driving method thereof.

2. Description of the Background Art

In general, a plasma display apparatus comprises a plasma display panel and a driver to drive the plasma display panel.

Typically, in a plasma display panel, a barrier rib formed between a front panel and a rear panel configures one discharge cell. Each of the discharge cells is filled with a main discharge gas such as neon (Ne), helium (He) or a mixture gas of Ne and He and an inert gas containing a trace amount of Xenon (Xe).

The discharge cells formed in multiple numbers configure one pixel. For instance, red (R) discharge cells, green (G) discharge cells and blue (B) discharge cells are grouped to configure one pixel.

When the plasma display panel is discharged by a high frequency voltage, the inert gas usually generates vacuum ultraviolet rays and causes phosphors formed between the barrier ribs to emit light, thereby implementing an image. Since such plasma display panel can be manufactured thin and light, it has been highlighted as a next generation display apparatus.

FIG. 1 illustrates a driving waveform of a typical plasma display apparatus.

As illustrated, each subfield SF comprises a reset period RP to initialize discharge cells of the entire screen, an address period AP to select discharge cells and a sustain period SP to sustain a discharge state of the selected discharge cells.

In the reset period RP, a positive ramp waveform PR is applied simultaneously to all scan electrodes Y during a set up interval SU. Due to the positive ramp waveform RP, a weak discharge (i.e., a set up discharge) occurs within the discharge cells of the entire screen, generating wall charges inside the discharge cells.

During a set down interval SD, a negative ramp waveform NR is applied simultaneously to the scan electrodes Y. The negative ramp waveform NR has a predetermined slope descending from a positive polarity direction (+) sustain voltage Vs that is less than a peak voltage of the positive ramp waveform PR to a negative polarity direction scan voltage −Vy.

The negative ramp waveform NR stimulates a generation of weak erase discharge within the discharge cells to erase unnecessary charges among the wall charges and space charges generated by the set up discharge. As a result, the wall charges generally required for an address discharge can remain in a consistent level inside the discharge cells of the entire screen.

In the address period AP, a negative polarity direction (−) scan pulse SCNP is applied sequentially to the scan electrodes Y and simultaneously, a positive polarity direction (+) data pulse DP is applied to address electrodes. When a voltage difference between the scan pulse SCNP and the data pulse DP is added with the wall charges generated during the reset period RP, an address discharge takes place inside the discharge cells to which the positive (+) polarity direction data pulse DP is applied. Due to the address discharge, wall charges are generated within the selected discharge cells.

During the set down interval SD and the address period AP, a positive (+) polarity direction sustain voltage Vs is applied to sustain electrodes Z.

During the sustain period SP, a sustain pulse SUSP is applied alternately to the scan electrodes Y and the sustain electrodes Z. Then, inside the selected discharge cells by the address discharge, a sustain discharge takes place in the form of a surface discharge between the scan electrodes Y and the sustain electrodes Z in every application of the sustain pulse SUSP as the wall charges of the selected discharge cells are added with the sustain pulse SUSP. Herein, the alternately applied sustain pulses SUSP have a voltage value same as that of the sustain voltage Vs.

FIG. 2 illustrates an arrangement of a typical plasma display apparatus.

As illustrated, discharge cells 1 are arranged at those intersection points where scan electrode lines Y1 to Yn, sustain electrode lines Z1 to Zn and address electrode lines (or data electrode lines) X1 to Xm intersect with each other.

The scan electrode lines Y1 to Yn supply a scan pulse and a sustain pulse to allow scanning of the discharge cells 1 in a line basis and sustaining of a discharge state inside the discharge cells 1.

The sustain electrode lines Z1 to Zn commonly supply the sustain pulse to allow sustaining of the discharge state inside the discharge cells 1 along with the scan electrode lines Y1 to Yn.

The address electrode lines X1 to Xm supply a data pulse, synchronized with the scan pulse, in a line basis to allow selection of parts of the discharge cells 1 that are to sustain the discharge state depending on the logic value of the data pulse.

The plasma display apparatus illustrated as in FIGS. 1 and 2 selects parts of the discharge cells 1 using the scan signal SCNP that is supplied sequentially to the scan electrode lines Y during the address period AP and the data signal (or address signal) that is supplied to the address electrode lines X.

FIG. 3 illustrates a simplified view of driving signals that are supplied to the electrodes during the address period and the selected discharge cells in the plasma display apparatus illustrated in FIG. 2.

The scan signal SCNP is supplied sequentially to the scan electrode lines Y to select the discharge cells where a marker discharge is to occur during the address period AP. As simultaneous to this selection, the data pulse DP is supplied to the address electrode lines X.

More specifically, while the scan signal SCNP is supplied to a first scan electrode line Y1, the data pulse DP of a positive (+) polarity direction is supplied to first and third discharge cells R1 and B1 where the marker discharge is to occur. The data pulse DP is not supplied to a second discharge cell G1 where the marker discharge is not to occur.

At this point, an address discharge takes place in the first and third discharge cells R1 and B1 due to the scan signal SCNP and the data pulse DP. The address discharge takes place due to the wall charges and a voltage difference between the voltage −Vy of the negative (−) polarity direction scan signal SCNP and the voltage Va of the positive (+) polarity direction data pulse DP.

A data driver 2 supplies the above data pulse DP to the address electrode lines X.

The data driver 2 is synchronized with a control signal CS supplied from an external control circuit such as a timing controller (not shown) and supplies signal voltages Va and GND that are supplied from a driving voltage generator (not shown) by a switching operation.

However, the typical plasma display panel (PDP) generally has a large voltage difference between the voltage Va of the data pulse DP in logic high and the voltage GND thereof in logic low.

Particularly, the voltage difference between the voltages in a logic high state and in a logic low state ranges from several tens of volts at the minimum to several hundreds of volts at the maximum.

This logic value difference in the data pulse DP becomes a burden to the data driver 2 which processes the data pulse DP. Such burden may result that a rated breakdown voltage of the data driver 2 has a more voltage than the voltage of the actually supplied data pulse DP in order to provide a large rated breakdown voltage that provides resistance to a high voltage of the data pulse.

That is, the data driver 2 tends to have a more rated breakdown voltage than the voltage Va of the data pulse DP in logic high, often increasing manufacturing costs.

The data driver 2 of the typical PDP may release a large amount of heat due to the high breakdown voltage, and as a result, devices are more likely to be damaged or perform erroneous operations.

### SUMMARY OF THE INVENTION

Accordingly, various embodiments of the present invention are directed to solve at least the problems and disadvantages of the background art.

The present invention provides a plasma display apparatus, which can decrease manufacturing costs and reduce damage to a data driver and erroneous operations of the data driver, and a driving method thereof.

According to an aspect of the present invention, a plasma display apparatus comprises a plasma display panel comprising address electrodes, a data driver for supplying a data voltage and a first voltage with a voltage that is more than a ground voltage to the address electrodes and a driving voltage generator for generating the first voltage and the data voltage and for supplying the first voltage and the data voltage to the data driver.

According to another aspect of the present invention, a driving method of a plasma display apparatus comprises supplying a ground voltage to address electrodes during a reset period, supplying a first voltage that is more than the ground voltage to the address electrodes during an address period, supplying a scan reference voltage to scan electrodes during the address period, supplying a data voltage to the address electrodes during the address period and supplying the ground voltage to the address electrodes during a sustain period.

According to a still another aspect of the present invention, a driving method of a plasma display apparatus comprises supplying a first voltage that is more than a ground voltage to address electrodes during a reset period, supplying the first voltage to the address electrodes during an address period, supplying a scan reference voltage to scan electrodes during the address period and supplying a data voltage to the address electrodes during the address period.

### BRIEF DESCRIPTION OF THE DRAWINGS

The invention will be described in detail with reference to the following drawings in which like numerals refer to like elements.

FIG. 1 illustrates a driving waveform generated by a typical plasma display apparatus.

FIG. 2 illustrates an electrode arrangement of a typical plasma display apparatus.

FIG. 3 illustrates a simplified view of driving signals that are supplied to electrodes during an address period and selected discharge cells in the plasma display apparatus illustrated in FIG. 2.

FIG. 4 illustrates a subfield pattern of an 8-bit default code to implement 256 gray scales in a plasma display apparatus according to an embodiment of the present invention.

FIG. 5 illustrates a block diagram of the plasma display apparatus according to an embodiment of the present invention.

FIG. 6 illustrates a data driver of the plasma display apparatus according to an embodiment of the present invention.

FIG. 7 illustrates a driving waveform generated by the plasma display apparatus according to an embodiment of the present invention.

FIG. 8 illustrates a driving waveform generated by the plasma display apparatus according to another embodiment of the present invention.

FIG. 9 illustrates the selection of a discharge cell by the driving waveform generated by the plasma display apparatus according to an embodiment of the present invention.

### DETAILED DESCRIPTION OF PREFERRED EMBODIMENTS

Embodiments of the present invention will be described in a more detailed manner with reference to the drawings.

According to an embodiment of the present invention, a plasma display apparatus comprises a plasma display panel comprising address electrodes, a data driver for supplying a data voltage and a first voltage with a voltage that is more than a ground voltage to the address electrodes, and a driving voltage generator for generating the first voltage and the data voltage and for supplying the first voltage and the data voltage to the data driver.

The data driver may comprise a first voltage supply controller for controlling a supply of the first voltage to the address electrodes, and a data voltage supply controller for controlling a supply of the data voltage to the address electrodes.

The first voltage supply controller may supply the first voltage continuously to the address electrodes during an address period; and the data voltage supply controller and the first voltage supply controller alternately drive.

The first voltage supply controller may comprise a second switch and a third switch.

The second switch and the third switch each may comprise a body diode; wherein an anode terminal of the body diode of the second switch is positional in a direction toward to face an anode terminal of the body diode of the third switch.

The first voltage may be more than the ground voltage and less than the data voltage.

The data driver may supply the ground voltage to the address electrodes during a reset period.

The first voltage may be more than the ground voltage and is less than a voltage subtracting a sum of a scan voltage supplied to scan electrodes and a wall voltage participating in a discharge from a firing voltage at which the discharge starts to be generated.

The first voltage may be more than 25% of a magnitude of the data voltage and is less than a voltage subtracting a sum of the scan voltage supplied to the scan electrodes and a wall voltage participating in a discharge from the firing voltage.

According to another embodiment of the present invention, a driving method of a plasma display apparatus comprises supplying a ground voltage to address electrodes during a reset period, supplying a first voltage that is more than the ground voltage to the address electrodes during an address period, supplying a scan reference voltage to scan electrodes during the address period, supplying a data voltage to the address electrodes during the address period, and supplying the ground voltage to the address electrodes during a sustain period.

The first voltage may be more than the ground voltage and less than a second voltage.

The first voltage may be more than the ground voltage and is less than a voltage subtracting a sum of a scan voltage supplied to scan electrodes and a wall voltage participating in a discharge from a firing voltage at which the discharge starts to be generated.

The first voltage may be more than 25% of a magnitude of the data voltage and is less than a voltage subtracting a sum of the scan voltage supplied to the scan electrodes and a wall voltage participating in a discharge from the firing voltage.

The scan reference voltage may be less than the ground voltage.

According to a still another embodiment of the present invention, a driving method of a plasma display apparatus comprises supplying a first voltage that is more than a ground voltage to address electrodes during a reset period, supplying the first voltage to the address electrodes during an address period, supplying a scan reference voltage to scan electrodes during the address period, and supplying a data voltage to the address electrodes during the address period.

The first voltage may be more than the ground voltage and less than the data voltage.

The first voltage may be more than the ground voltage and is less than a voltage subtracting a sum of a scan voltage supplied to scan electrodes and a wall voltage participating in a discharge from a firing voltage at which the discharge starts to be generated.

The first voltage may be more than 25% of a magnitude of the data voltage and is less than a voltage subtracting a sum of the scan voltage supplied to the scan electrodes and a wall voltage participating in a discharge from the firing voltage.

The scan reference voltage may be less than the ground voltage.

Hereinafter, various exemplary embodiments on a plasma display apparatus and a driving method thereof will be described in detail with reference to the accompanying drawings.

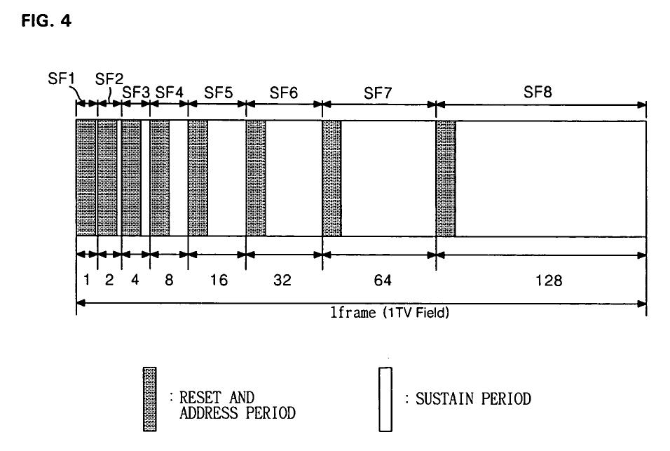

FIG. 4 illustrates a subfield pattern of an 8-bit default code to implement 256 gray scales in a plasma display apparatus according to an embodiment of the present invention.

To implement a gray scale of an image, a plasma display apparatus drives on a time divisional basis by which one frame is divided into several subfields having different emitting numbers.

Each of the subfields is divided into three parts including a reset period, an address period and a sustain period. The reset period is to initialize a previous image, the address period to select a scan line and select a discharge cell in the selected scan line, and the sustain period to implement a gray scale according to the number of discharge.

For example, when an image is displayed in 256 gray scales, a frame period corresponding to 1/60 seconds, i.e., 16.67 ms, is divided into eight subfields SF1 to SF8. Each of the eight subfields SF1 to SF8 is divided into a reset period RP, an address period AP and a sustain period SP.

The reset period RP and the address period AP of the individual subfield are substantially the same. However, the sustain period of the individual subfield and the number of sustain pulses assigned thereto increase by a factor of 2n, where n=0, 1, 2, 3, 4, 5, 6, and 7.

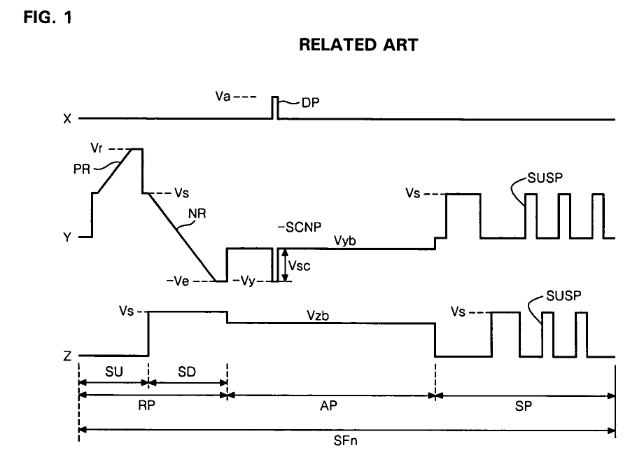

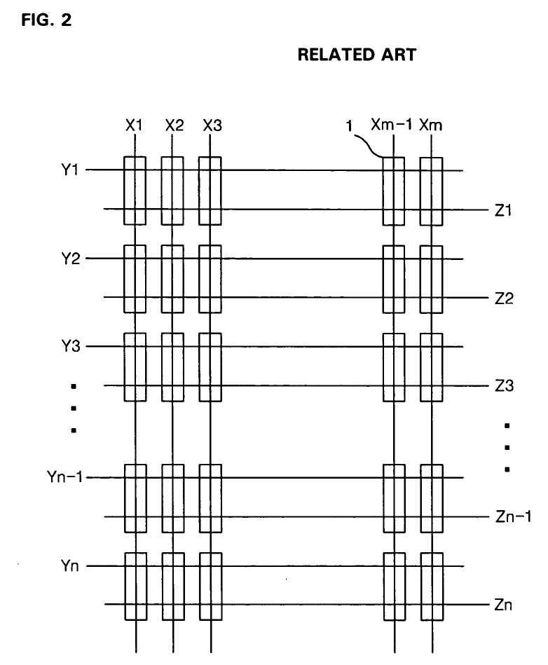

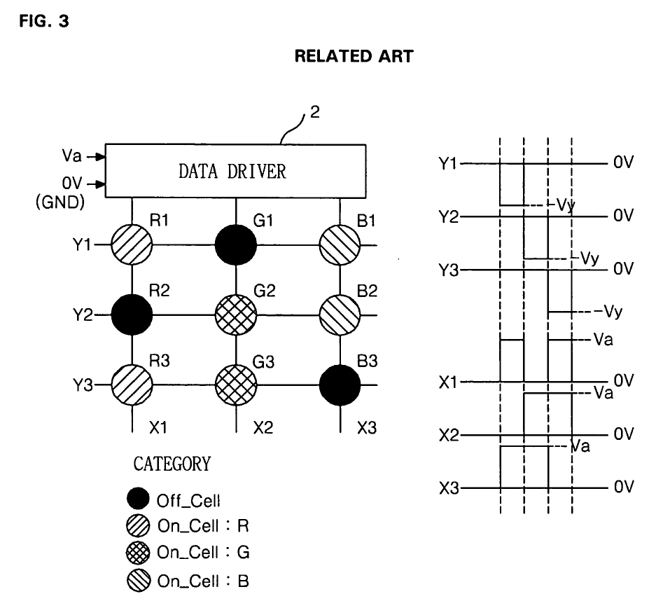

Particularly, FIG. 4 illustrates one example of the subfield pattern that can be applied to the plasma display apparatus according to the present invention. It should be noted that the present invention is not limited to the subfield pattern illustrated in FIG. 1.

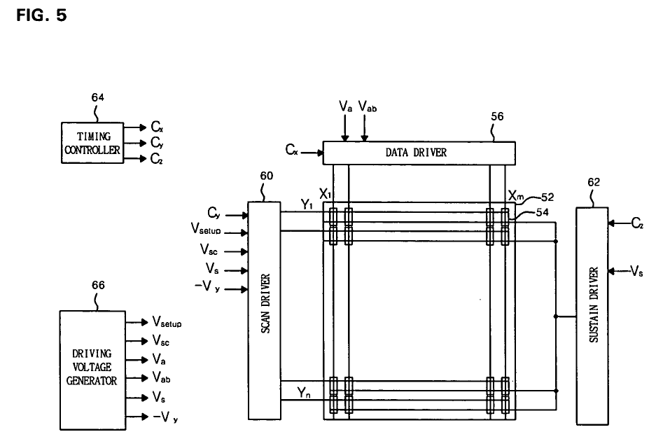

FIG. 5 illustrates a block diagram of a plasma display apparatus according to an embodiment of the present invention.

As illustrated, the plasma display apparatus comprises a PDP 52, a data driver 56, a scan driver 60, a sustain driver 62, a timing controller 64, and a driving voltage generator 66. The PDP 52 displays an image. The data driver 56 supplies red (R), green (G) and blue (B) data to address electrodes X1 to Xm of discharge cells 54 coated with R, G and B phosphors. The scan driver 60 drives scan electrodes Y1 to Yn of the PDP 52. The sustain driver 62 drives sustain electrodes Z of the PDP 52. The timing controller 64 controls the data driver 56, the scan driver 60 and the sustain driver 62, and the driving voltage generator 66 generates driving voltages necessary for the data driver 56, the scan driver 60 and the sustain driver 62.

The PDP 52 comprises a front substrate where the scan electrodes Y1 to Yn and the sustain electrodes Z are formed, and a rear substrate where the address electrodes X1 to Xm are formed.

Discharge cells 54 are arranged at those points where the scan electrodes Y1 to Yn, the sustain electrodes Z and the address electrodes X1 to Xm intersect with each other.

The discharge cells 54 are coated with R, G and B phosphors and driven by driving waveforms supplied from the data driver 56, the scan driver 60 and the sustain driver 62.

The data driver 56 samples R, G and B data in response to a timing control signal Cx supplied from the timing controller 64 and latches the R, G and B sampled data, and data voltages Va of the latched R, G and B data are supplied to the address electrodes X1 to Xm of the discharge cells 54 coated with the R, G and B phosphors.

The data driver 56 can be driven separately as a first data driver and a second data driver. The first data driver and the second data driver are disposed up and down or left and right.

Particularly, when the first data driver supplies two of the R, G and B data to some of the address electrodes X1 to Xm, the second data driver supplies the other data to the other address electrodes X1 to Xm.

A first voltage Vab that is a positive polarity direction bias voltage is supplied to the data driver 56 to reduce breakdown voltage caused by a voltage applied to the data driver 56 by the data voltage Va.

The first voltage Vab supplied to the data driver 56 is more than a ground voltage (0 V) GND and less than the data voltage Va.

The first voltage Vab supplied to the data driver 56 decreases a voltage difference (Va−Vab) and thus reduces breakdown voltage applied to the data driver 56. However, a voltage difference (Va−Vy) between the data voltage Va and the scan voltage Vy of the scan pulse SCNP has substantially the same as that of the related art. Therefore, the address discharge is normally performed. This operation will be described later in detail.

During the reset period, the scan driver 60 supplies initialization waveforms to the scan electrodes Y1 to Yn in response to a timing control signal Cy supplied from the timing controller 64. During the address period AP, the scan driver 60 supplies a scan reference voltage Vyb and the scan pulse SCNP in sequence.

The scan reference voltage Vyb may be less than the ground voltage.

During the sustain period. SP, the scan driver 60 supplies a sustain pulse SUSP to the scan electrodes Y1 to Yn in response to the timing control signal Cy supplied from the timing controller 64.

During a set down period SD and the address period AP, the sustain driver 62 supplies a positive polarity direction sustain voltage Vs to the sustain electrodes Z in response to a timing control signal Cz supplied from the timing controller 64. Afterwards, the sustain driver 62 and the scan driver 60 operate alternately during the sustain period SP to supply the sustain pulse SUSP to the sustain electrodes Z.

The timing controller 64 receives horizontal/vertical synchronization signals and a clock signal, generates the timing control signals Cx, Cy and Cz necessary for the respective drivers 56, 58, 60 and 62, and supplies the timing control signals Cx, Cy and Cz to control the respective drivers 56, 58, 60 and 62.

The timing control signal Cx comprises a sampling clock that samples data, a latch control signal, and a switch control signal to control an on/off time of an energy recollection circuit and a driving switching device.

The timing control signal Cy comprises a switch control signal to control an on/off time of an energy recollection circuit within the scan driver 60 and the driving switching device.

The timing control signal Cz comprises a switch control signal to control an on/off time of an energy recollection circuit within the sustain driver 62 and the driving switching device.

The driving voltage generator 66 generates a set up voltage Vsetup, a negative polarity direction scan voltage Vy, a scan bias voltage Vsc, and a positive polarity direction sustain voltage Vs and supplies these mentioned voltages Vsetup, Vy, Vsc, and Vs to the scan driver 60 and the sustain driver 62.

The driving voltage generator 66 generates the data voltage Va corresponding to the R, G and B data, and supplies the data voltage Va to the data driver 56.

In addition, the driving voltage generator 66 supplies the first voltage Vab, i.e., the positive polarity direction bias voltage, to the data driver 56 so as to reduce breakdown voltage usually caused by the data voltage Va.

Equation 1 below represents the relationship between the data voltage Va, the scan voltage Vy, the wall voltage Vwall, and a firing voltage Vf for the address discharge.
Va+|V_{y}|+V_{wall}>Vⱼ [Equation 1]

Like Equation 1, the discharge condition for the discharge cells selected during the address period AP is that the sum of the data voltage Va, the scan voltage Vy and the wall voltage Vwall should be greater than the firing voltage Vf. Specifically, when the sum of the data voltage Va, the scan voltage Vy and the wall voltage Vwall is greater than the firing voltage Vf, the address discharge is performed, and the discharge cells in which the sustain discharge will occur are selected.

Likewise, since the scan voltage Vy and the data voltage Va are not applied to off-cells in which the sustain discharge does not occur, a voltage less than the firing voltage Vf is maintained. This relationship is expressed as Equation 2.
V_{ab}+|V_{y}|+V_{wall}<Vⱼ [Equation 2]

Specifically, since only the first voltage Vab, the wall voltage Vwall and the scan voltage Vy applied to the address electrodes X1 to Xm are applied, the voltage necessary for the discharge is insufficient as much as the voltage difference between the data voltage Va and the first voltage Vab. Thus, even though the first voltage Vab is applied, discharge does not occur in off-cells.

Therefore, the magnitude of the first voltage Vab is defined as Equation 3 below.
GND<V_{ab}<V_{f}−|V_{y}|−V_{wall} [Equation 3]

That is, the first voltage Vab is particularly more than the ground voltage GND and less than a voltage obtained by subtracting the scan voltage Vy and the wall voltage Vwall from the firing voltage Vf.

More particularly, the first voltage Vab is more than 25% of a magnitude the data voltage (Va/4) and less than the voltage obtained by subtracting the scan voltage Vy and the wall voltage Vwall from the firing voltage Vf.

The first voltage Vab should be determined within a range where breakdown voltage applied to the data driver 56 can be reduced most efficiently, while discharge does not occur during a period in which a data pulse DP is not applied.

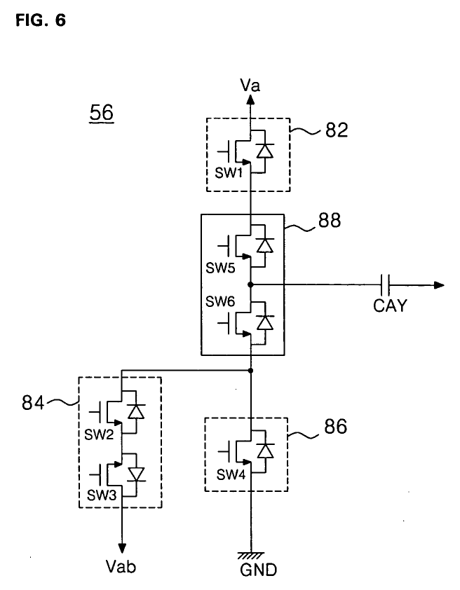

FIG. 6 illustrates a data driver of the plasma display apparatus according to an embodiment of the present invention.

The data driver 56 comprises a data voltage supply controller 82, a first voltage supply controller 84, a ground voltage supply controller 86, and a data integrated circuit (IC) 88. The data voltage supply controller 82 controls the supply of the data voltage Va to the address electrodes X1 to Xm. The first voltage supply controller 84 controls the supply of the first voltage Vab to the address electrodes X1 to Xm. The ground voltage supply controller 86 controls the supply of the ground voltage GND to the address electrodes X1 to Xm.

The data voltage supply controller 82 controls the supply of the data voltage Va to the address electrodes X1 to Xm during the address period according to the control signal Cx supplied from the timing controller 64.

The data voltage supply controller 82 comprises a first switch SW1 coupled between a data voltage source Va and the data IC 88.

The first voltage supply controller 84 controls the supply of the first voltage Vab to the address electrodes X1 to Xm during the address period according to the control signal Cx supplied from the timing controller 64.

At this point, the first voltage supply controller 84 and the data voltage supply controller 82 alternately drive. Specifically, when the data voltage Va is supplied to the address electrodes X1 to Xm by the data voltage supply controller 82, the first voltage supply controller 84 does not operate. However, when the first voltage Vab is supplied to the address electrodes X1 to Xm by the first voltage supply controller 84, the data voltage supply controller 82 does not operate.

The first voltage supply controller 84 comprises a second switch SW2 and a third switch SW3 coupled in series between the first voltage source Vab and the data IC 88.

When the data voltage Va is supplied to the address electrodes X1 to Xm, a body diode of the second switch SW2 prevents a reverse current flowing from the data IC 88 to the first voltage source Vab. When the ground voltage GND is supplied to the address electrodes X1 to Xm, a body diode of the third switch SW3 prevents a reverse current flowing from the first voltage source Vab.

The ground voltage supply controller 86 controls the supply of the ground voltage GND to the address electrodes X1 to Xm during the reset period and the sustain period according to the control signal Cx supplied from the timing controller 64.

The ground voltage supply controller 86 comprises a fourth switch SW4 coupled in parallel to the first voltage supply controller 84 between the ground voltage source GND and the data IC 88.

When the data voltage Va and the first voltage Vab are supplied to the address electrodes X1 and Xm, a body diode of the fourth switch SW4 prevents a reverse current flowing from the data IC 88 to the ground voltage source GND.

The data IC 88 is coupled to the address electrodes X1 to Xm and supplies the data voltage Va, the first voltage Vab and the ground voltage GND to the address electrodes X1 to Xm according to the control signal Cx supplied from the timing controller 64.

The data IC 88 comprises a fifth switch SW5 coupled between the data voltage supply controller 82 and the address electrodes X1 to Xm, and a sixth switch SW6 coupled between the address electrodes X1 to Xm and a common node of the first voltage supply controller 84 and the ground voltage supply controller 86.

In the plasma display apparatus of the present embodiment, when the data driver 56 supplies the data voltage Va to the address electrodes X1 to Xm, the voltage is distributed to the second switch SW2 and the third switch SW3 of the first voltage supply controller 84 and the fourth switch SW4 of the ground voltage supply controller 86. Therefore, breakdown voltage conditions of the switches SW1 to SW4 are reduced.

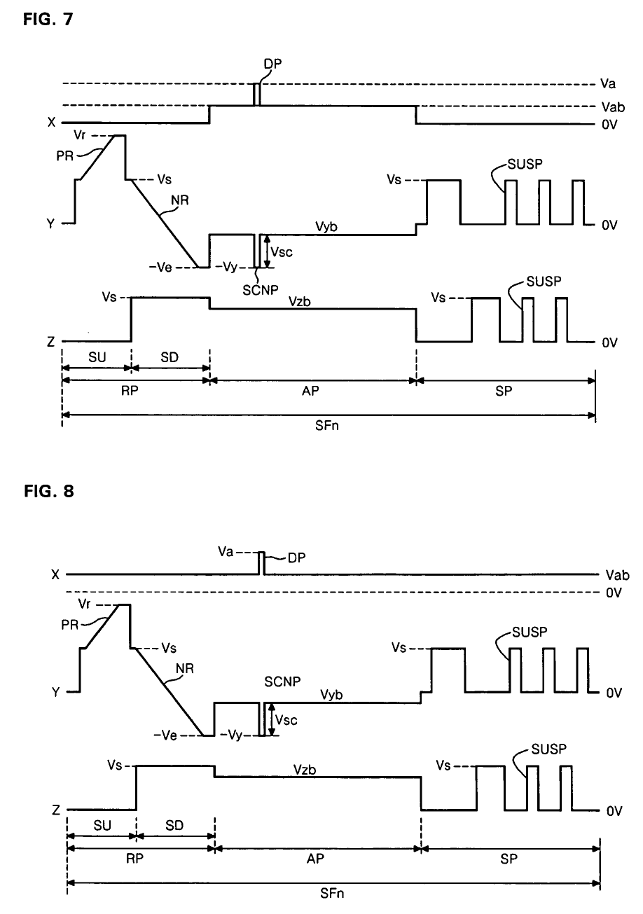

FIG. 7 illustrates a driving waveform generated by the plasma display apparatus according to an embodiment of the present invention.

The plasma display apparatus comprises a reset period RP, an address period AP, and a sustain period SP. The reset period RP is to initialize discharge cells of the entire screen. The address period AP is to select certain discharge cells, and the sustain period SP is to sustain a discharge state of the selected discharge cells.

During a set up period SU of the reset period RP, the scan electrodes Y are applied with a positive ramp waveform PR. The ground voltage (0 V) is applied to the sustain electrodes Z and to the address electrodes X.

Accordingly, the positive ramp waveform PR causes a dark discharge to occur in the entire discharge cells during the set up period SU, so that light is not almost generated between the scan electrodes Y and the address electrodes X. At the same time, a dark discharge also occurs between the scan electrodes Y and the sustain electrodes Z.

As a result of this dark discharge, just after the set up period SU, positive wall charges remain over the address electrodes X and the sustain electrodes Z, while negative wall charges remain over the scan electrodes Y within the entire discharge cells.

During a set down period SD after the set up period SU, a negative ramp waveform NR is applied to the scan electrodes Y. A voltage of the negative ramp waveform NR goes down from the sustain voltage Vs to a negative erase voltage Ve at a predetermined slope.

At the same time, the positive polarity direction sustain voltage Vs is applied to the sustain electrodes Z. The ground voltage GND is applied to the address electrodes X.

The negative ramp waveform NR causes a dark discharge to occur in the entire discharge cells 54. At the same time, the dark discharge occurs between the scan electrodes Y and the sustain electrodes Z.

As a result, the discharge cells 54 have a uniform wall charge distribution optimized to the addressing condition. More specifically, an exceeding amount of wall charges unnecessary for the address discharge is erased from the scan electrodes Y and the address electrodes X within the respective discharge cells 54, and a predetermined amount of wall charges remains.

The polarity of the wall charges over the sustain electrodes Z changes from positive to negative while negative wall charges moving from the scan electrodes Y are accumulated.

During an initial stage of the address period AP, when the first voltage Vab is applied to the address electrodes X and the negative polarity direction scan pulse SCNP is sequentially applied to the scan electrodes Y, the data pulse DP having the data voltage Va is applied to the address electrodes X in synchronization with the scan pulse SCNP.

Also, the negative polarity direction sustain voltage Vs or positive bias voltage Vzb less than the negative polarity direction sustain voltage Vs is applied to the sustain electrodes Z.

The first voltage Vas is more than the ground voltage (0 V) and less than the data voltage Va.

The scan pulse SCNP is a scan voltage Vsc that goes down from approximately 0 V or a negative polarity direction scan bias voltage close to approximately 0 V to a negative polarity direction scan voltage −Vy. Therefore, during the address period AP, the address discharge occurs between the scan electrodes Y and the address electrodes X within on-cells to which the scan voltage Vsc and the data voltage Va are applied.

During the sustain period SP, the sustain pulse SUSP of the sustain voltage level Vs is alternately applied to the scan electrodes Y and the sustain electrodes Z, and the ground voltage is applied to the address electrodes X.

In the on-cells selected by the address discharge, the sustain discharge occurs between the scan electrodes Y and the sustain electrodes Z in every application of the sustain pulse SUSP.

However, no sustain discharge occurs in the off-cells during the sustain period SP.

In the plasma display apparatus and the driving method thereof according to an embodiment of the present invention, the ground voltage is applied to the address electrodes X during the reset period RP and the sustain period SP. During the remaining address period in which no data pulse DP is applied, the first voltage Vab more than the ground voltage (0 V) and less than the data voltage Va is applied to the address electrodes X, thus reducing breakdown voltage.

That is, the breakdown voltage applied to the data driver is reduced as much as the voltage difference between the positive polarity direction bias voltage Vas and the reference voltage (0 V, GND), thus reducing a voltage burden to the data driver.

FIG. 8 illustrates a driving waveform generated by the plasma display apparatus according to another embodiment of the present invention.

Referring to FIG. 8, the plasma display apparatus comprises a reset period RP, an address period AP, and a sustain period SP. The reset period RP is to initialize discharge cells of the entire screen. The address period AP is to select certain discharge cells, and the sustain period SP is to sustain a discharge state of the selected discharge cells.

During a set up period SU of the reset period RP, the scan electrodes Y are applied with a positive ramp waveform PR. The ground voltage (0 V) is applied to the sustain electrodes Z and the first voltage Vab of the positive polarity direction is applied to the address electrodes X.

The first voltage Vab is more than the ground voltage (0 V) and less than the data voltage Va.

Accordingly, the positive ramp waveform PR causes a dark discharge to occur in the entire discharge cells during the set up period SU, so that light is not almost generated between the scan electrodes Y and the address electrodes X. At the same time, a dark discharge also occurs between the scan electrodes Y and the sustain electrodes Z.

As a result of this dark discharge, just after the set up period SU, positive wall charges remain over the address electrodes X and the sustain electrodes Z, while negative wall charges remain over the scan electrodes Y within the entire discharge cells.

During a set down period SD after the set up period SU, a negative ramp waveform NR is applied to the scan electrodes Y. A voltage of the negative ramp waveform NR goes down from the sustain voltage Vs to a negative erase voltage Ve at a predetermined slope.

At the same time, the positive polarity direction sustain voltage Vs is applied to the sustain electrodes Z. The first voltage Vab is applied to the address electrodes X.

The negative ramp waveform NR causes a dark discharge to occur in the entire discharge cells 54. At the same time, the dark discharge occurs between the scan electrodes Y and the sustain electrodes Z.

As a result, the discharge cells have a uniform wall charge distribution optimized to the addressing condition.

More specifically, an exceeding amount of wall charges unnecessary for the address discharge is erased from the scan electrodes Y and the address electrodes X within the respective discharge cells 54, and a predetermined amount of wall charges remains.

The polarity of wall charges over the sustain electrodes Z changes from positive to negative while negative wall charges moving from the scan electrodes Y are accumulated.

During the address period AP, the negative polarity direction scan signal SCNP is sequentially applied to the scan electrodes Y, and the positive polarity direction data pulse DP is applied to the address electrodes Y in synchronization with the scan signal SCNP. The positive polarity direction sustain voltage Vs or positive polarity direction bias voltage Vzb less than the positive polarity direction sustain voltage Vs is applied to the sustain electrodes Z.

The scan pulse SCNP is a scan voltage Vsc that goes down from approximately 0 V or a negative polarity direction scan bias voltage close to approximately 0 V to a negative polarity direction scan voltage −Vy.

Therefore, during the address period AP, the address discharge occurs between the scan electrodes Y and the address electrodes X within the on-cells to which the scan voltage Vsc and the data voltage Va are applied.

During the sustain period SP, the sustain pulse SUSP of the sustain voltage level Vs is alternately applied to the scan electrodes Y and the sustain electrodes Z.

In the on-cells selected by the address discharge, the sustain discharge occurs between the scan electrodes Y and the sustain electrodes Z in every application of the sustain pulse SUSP.

However, no sustain discharge occurs in the off-cells during the sustain period SP.

In the plasma display apparatus and the driving method thereof according to the present embodiment, during the other period in which no data pulse DP is applied among the reset period RP, the sustain period SP and the address period AP, the first voltage Vab more than the ground voltage (0 V) and less than the data voltage Va is applied to the address electrodes X, thus reducing breakdown voltage.

During the period in which no data pulse DP is applied, breakdown voltage applied to the data driver can be reduced by the positive polarity bias voltage Vab applied to the address electrodes X.

That is, the breakdown voltage applied to the data driver is reduced as much as the voltage difference between the positive polarity direction bias voltage Vas and the ground voltage GND, thus reducing a voltage burden to the data driver.

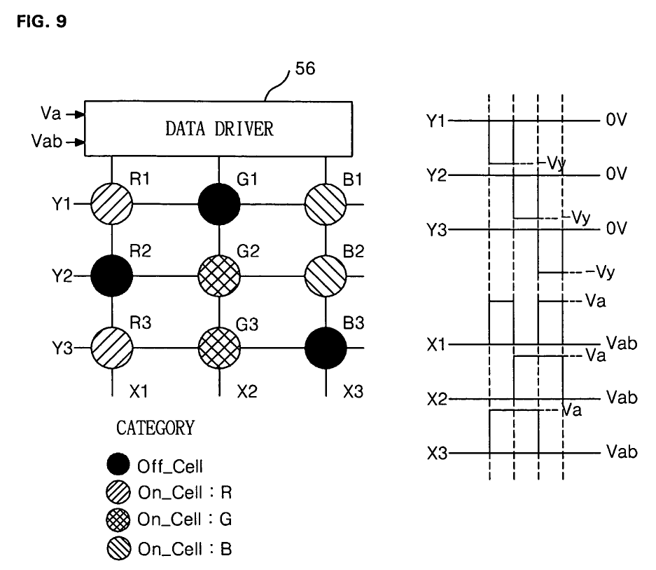

FIG. 9 illustrates the selection of the discharge cell by the driving waveform generated by the plasma display apparatus according to an embodiment of the present invention.

It can be seen from FIG. 9 that the voltage supplied to the data driver 56 is changed into the data voltage Va and the positive polarity direction bias voltage Vab.

However, the waveform applied for the operation is not changed. The rated breakdown voltage of the data driver 56 can be reduced by applying the positive polarity direction bias voltage Vab, instead of the ground voltage GND supplied from the data driver 56. Therefore, the data driver 56 can be implemented at low cost.

During the intervals of the address period in which the no data pulse is supplied, breakdown voltage of the data driver can be reduced as much as the positive polarity direction bias voltage by supplying the address electrodes with the positive polarity direction bias voltage more than the ground voltage and less than the data voltage.

In addition, since the data driver has a low breakdown voltage, heat from the data driver can be reduced, and the damage and malfunction of the driving device can be reduced.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising address electrodes;
a data driver for supplying a data voltage and a first voltage with a voltage that is more than a ground voltage to the address electrodes; and
a driving voltage generator for generating the first voltage and the data voltage and for supplying the first voltage and the data voltage to the data driver.

2. The plasma display apparatus of claim 1, wherein the data driver comprises:
a first voltage supply controller for controlling a supply of the first voltage to the address electrodes; and
a data voltage supply controller for controlling a supply of the data voltage to the address electrodes.

3. The plasma display apparatus of claim 2, wherein the first voltage supply controller supplies the first voltage continuously to the address electrodes during an address period; and the data voltage supply controller and the first voltage supply controller alternately drive.

4. The plasma display apparatus of claim 2, wherein the first voltage supply controller comprises a second switch and a third switch.

5. The plasma display apparatus of claim 4, wherein the second switch and the third switch each comprises a body diode; wherein an anode terminal of the body diode of the second switch is positional in a direction toward to face an anode terminal of the body diode of the third switch.

6. The plasma display apparatus of claim 1, wherein the first voltage is more than the ground voltage and less than the data voltage.

7. The plasma display apparatus of claim 1, wherein the data driver supplies the ground voltage to the address electrodes during a reset period.

8. The plasma display apparatus of claim 1, wherein the first voltage is more than the ground voltage and is less than a voltage subtracting a sum of a scan voltage supplied to scan electrodes and a wall voltage participating in a discharge from a firing voltage at which the discharge starts to be generated.

9. The plasma display apparatus of claim 8, wherein the first voltage is more than 25% of a magnitude of the data voltage and is less than a voltage subtracting a sum of the scan voltage supplied to the scan electrodes and a wall voltage participating in a discharge from the firing voltage.

10. A driving method of a plasma display apparatus, the driving method comprising:
supplying a ground voltage to address electrodes during a reset period;
supplying a first voltage that is more than the ground voltage to the address electrodes during an address period;
supplying a scan reference voltage to scan electrodes during the address period;
supplying a data voltage to the address electrodes during the address period; and
supplying the ground voltage to the address electrodes during a sustain period.

11. The driving method of claim 10, wherein the first voltage is more than the ground voltage and less than a second voltage.

12. The driving method of claim 10, wherein the first voltage is more than the ground voltage and is less than a voltage subtracting a sum of a scan voltage supplied to scan electrodes and a wall voltage participating in a discharge from a firing voltage at which the discharge starts to be generated.

13. The driving method of claim 12, wherein the first voltage is more than 25% of a magnitude of the data voltage and is less than a voltage subtracting a sum of the scan voltage supplied to the scan electrodes and a wall voltage participating in a discharge from the firing voltage.

14. The driving method of claim 10, wherein the scan reference voltage is less than the ground voltage.

15. A driving method of a plasma display apparatus, the driving method comprising:
supplying a first voltage that is more than a ground voltage to address electrodes during a reset period;
supplying the first voltage to the address electrodes during an address period;
supplying a scan reference voltage to scan electrodes during the address period; and
supplying a data voltage to the address electrodes during the address period.

16. The driving method of claim 15, wherein the first voltage is more than the ground voltage and less than the data voltage.

17. The driving method of claim 15, wherein the first voltage is more than the ground voltage and is less than a voltage subtracting a sum of a scan voltage supplied to scan electrodes and a wall voltage participating in a discharge from a firing voltage at which the discharge starts to be generated.

18. The driving method of claim 17, wherein the first voltage is more than 25% of a magnitude of the data voltage and is less than a voltage subtracting a sum of the scan voltage supplied to the scan electrodes and a wall voltage participating in a discharge from the firing voltage.

19. The driving method of claim 15, wherein the scan reference voltage is less than the ground voltage.
